(19) United States
(12) Patent Application Publication
(10) Pub. No.: US 2007/0147348 A1
(43) Pub. Date: Jun. 28, 2007

(54) Methods, systems, and computer program products for providing location information for VoIP emergency calling

(76) Inventor: Tingting Lu, Alpharetta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/318,110

(22) Filed: Dec. 23, 2005

(51) Int. Cl. H04L 12/66

(52) U.S. Cl. 370/352

(57) ABSTRACT

A method for providing location information for VoIP emergency calling including: providing a location information database in operable communication with a location information server; maintaining a location information record corresponding to a physical location; associating a VoIP device with a location information record; receiving a request for the physical location of the VoIP device; and providing the physical location of the VoIP device.

### BACKGROUND

This disclosure relates generally to providing emergency, or 911, services for Internet Protocol (IP) communication devices, and is more specifically directed to resolving the location of IP communication devices in order to provide emergency services in response to an emergency call.

Emergency services are available in the United States by dialing “911 ”from a conventional wireline telephone. Such calls are routed to a public safety answering point (PSAP) based on the telephone number of the calling party which is available by calling line identification (CLI). The telephone number of the calling party is used to determine the appropriate PSAP, normally the closest PSAP to the calling party, to receive the emergency call. An automatic location identifier (ALI) database in the public switched telephone network (PSTN) contains records that associate telephone numbers to geographic locations.

The availability of 911 emergency services has become complicated by the growing popularity of IP communication devices. Since an IP communication device can be moved by the user to any available IP port maintained by the provider of IP telephony services subscribed to by the user, the directory number (DN) assigned to an IP communication device cannot be assumed to correspond with a specific location of the user. For example, an employee normally uses his IP phone in a home office in Atlanta but elects to take the IP phone to a remote office in New York City that also supports IP telephony services for the company. The telephone number of the IP phone does not change when the employee uses it in New York City. Therefore, the telephone numbers of IP phones cannot be relied upon to determine the current location of the user.

There are various different Voice-over-IP (VoIP) scenarios that require 911 services. The VoIP device can be physically connected to a static data cable at a “home” address, the VoIP device can be physically connected to a data cable at a location different than its “home” address, or the VoIP device is wireless, physically disconnected from any data cable. In this situation, the VoIP device connects to the VoIP network via cellular or WiFi technology. The portability of the VoIP devices presents several problems with the use of the current location determination of the emergency services.

It is important to be able to automatically determine the geographic location of the user associated with an emergency call since the user may become incapacitated or otherwise unavailable to provide location information to a 911 operator. Thus, there exists a need to be able to determine the geographic location of IP telephone users requesting emergency 911 services.

### SUMMARY

Exemplary embodiments include a method for providing location information for VoIP emergency calling including: providing a location information database in operable communication with a location information server; maintaining a location information record corresponding to a physical location; associating a VoIP device with a location information record; receiving a request for the physical location of the VoIP device; and providing the physical location of the VoIP device.

Exemplary embodiments also include a computer program product for providing location information for VoIP emergency calling, the computer program product including: a storage medium readable by a processing circuit and storing instructions for execution by the processing circuit for facilitating a method including: providing a location information database in operable communication with a location information server; maintaining a location information record corresponding to a physical location; associating a VoIP device with a location information record; receiving a request for the physical location of the VoIP device; and providing the physical location of the VoIP device.

Further exemplary embodiments include a system for providing location information for VoIP emergency calling including: means for operating a location information database; means for maintaining a location information record corresponding to a physical location; means for associating a VoIP device with a location information record; means for receiving a request for the physical location of the VoIP device; and means for providing the physical location of the VoIP device.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several Figures:

FIG. 1 is a block diagram of a VoIP location determination system in accordance with exemplary embodiments;

FIG. 2 is a flow chart of a method for providing location information for VoIP emergency calling in accordance with exemplary embodiments;

FIG. 3 is a block diagram of a location information record in accordance with exemplary embodiments; and

FIG. 4 is a flow chart of a method for maintaining a location information database in accordance with exemplary embodiments.

### DETAILED DESCRIPTION

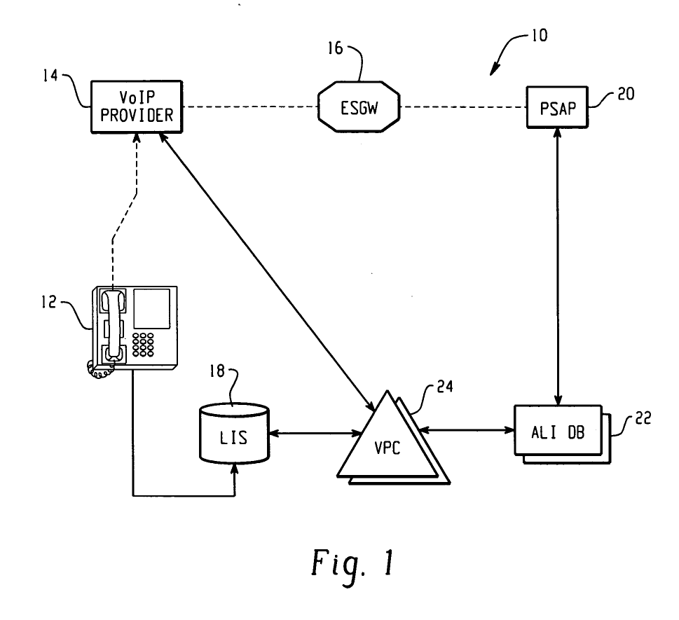

Referring to FIG. 1, a block diagram of an exemplary VoIP location determination system is generally depicted as 10. The VoIP location determination system 10 includes a VoIP device 12, a VoIP provider 14, an Emergency Service Gateway (ESGW) 16, a Location Information Server (LIS) 18, a PSAP 20, an Automatic Location Identifier Database (ALI DB) 22, and a Voice Position Center (VPC) 24. The VoIP device 12 can include a variety of different types of VoIP devices including, but not limited to, phones, Smart Phones & PDAs, laptop computers, or desktop computers. The VoIP provider 14 is in operable communication with the VoIP device 12 over a communications connection. Additionally, the VoIP provider 14 is in operable communication with the LIS 18. The communications connection may include, but is not limited to, a DSL connection, a cable modem connection, a T1 connection, a T3 connection, an 802.11 connection, or the like. The VoIP device 12 has an associated Internet Protocol (IP) address, which may be supplied by the VoIP provider 14. The VoIP provider 14 is in operable communication with the ESGW 16 and upon receiving an emergency call, the VoIP provider 14 connects the emergency call to the PSAP 20 through the ESGW 16. The PSAP 20 receives the emergency call and dispatches the appropriate emergency services.

In exemplary embodiments the PSAP 20 may receive the location information corresponding to the VoIP device 12 from the ALI DB 22. In alternative exemplary embodiments, the PSAP 20 may receive the location information corresponding to the VoIP device 12 from the VoIP provider 14. In either case, the LIS 18 is queried for the location information corresponding to the VoIP device 12 that is placing the emergency call. Since, the LIS 18 is the primary source for the location information to the PSAP 20, the quality of the information in the records in the LIS 18 is important. The quality of the information contained within the LIS 18 includes, but is not limited to, the completeness of the information, the accuracy of the information, and the up-to-datedness of the information. As discussed above, the VoIP device 12 is designed such that a user may easily move it from one physical location to another. For at least these reasons, a method for providing location information for VoIP emergency calling is needed.

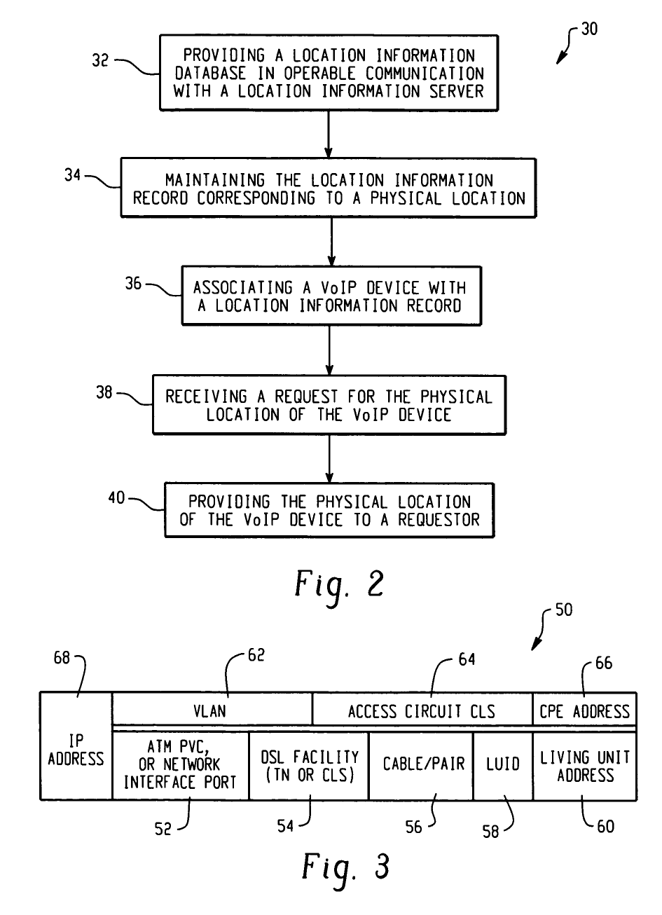

Turning now to FIG. 2, a flow chart of a method for providing location information for emergency calling is generally depicted as 30. The method includes providing a location information database in operable communication with a location information server, as shown at process block 32. In exemplary embodiments, the location information database includes a plurality of location information records that may be stored on the location information server. The method also includes maintaining the location information record corresponding to a physical location, as shown at process block 34. The location information record may be automatically updated when changes are made to a Master Street Address Guide (MSAG) or a Regional Street Address Guide (RSAG) that is maintained by the provider of the communications service at the physical location. The MSAG and RSAG are databases maintained by the providers of communications services such as DSL, POTS, Cable Modem, and the like which include the physical address, name, account number, and other information about the physical communications services at the physical address.

Continuing with reference to FIG. 2, the method also includes associating a VoIP device with a location information record, as shown at process block 36. In exemplary embodiments, the VoIP device receives an Internet Protocol address once connected to a physical location and the VoIP device communicates its IP address to the VoIP provider. The VoIP provider and/or the VoIP device communicates with the location information database to provide the IP address and location and a location identifier of the VoIP device to the location information database. The location information database then updates the corresponding location information record with the IP address of the VoIP device. After the VoIP device is connected to the Internet and has established a connection to the VoIP provider an emergency call can be made from the VoIP device. Once an emergency call is made from the VoIP device, the method for providing location information for emergency calling includes receiving a request for the physical location of the VoIP device, as shown at process block 38. In exemplary embodiments, the request for the physical location of the VoIP device includes the IP address of the VoIP device. Once the request is received, the location information database can be queried for the physical address corresponding to the IP address provided. The method concludes by providing the physical location of the VoIP device to a requester, as shown at process block 40.

In exemplary embodiments, the location information database includes one or more location information records, which correspond to communications connections at physical locations. FIG. 3 illustrates a block diagram of an exemplary location information record that is generally depicted as 50. The location information record may include, but is not limited to, a network interface field 52, a facility identification field 54, a cable or wire identification field 56, a living unit identification filed 58, and a living unit address field 60. In commercial applications when a user may have a private network which includes several physical locations the user may specify additional information for the location information record including, but not limited to, a virtual local area network field 62, an access circuit field 64, and an address field 66. In exemplary embodiments, the network interface field 52 may also be an ATM virtual circuit identifier, an Ethernet virtual LAN identifier, or a network interface port identifier. Additionally, the location information record may have an associated IP address of a VoIP device connected to the physical location stored in an IP address field 68. In exemplary embodiments the IP address can be used as the primary key of the location information database, since no two VoIP devices can share the same IP address.

In an exemplary embodiment, a location information record can be added to the location information database when the telecommunications provider receives a request to add a broadband communications line to a physical address (e.g., a customer ordering a new DSL line). The telecommunications provider may receive the request to issue a new service order through a retain negotiation system and check the address for the new service order against the regional street address guide to determine if service is currently being provided to the address. If the address is not present in the street address guide, it is added to the street address guide and a work order to install a new physical connection is issued. Once the address is located in the street address guide, the new service order along with the address information is passed to a service order entry gateway. The service order entry gateway, through a service order control system, communicates the information corresponding to the new broadband communications to the location information server.

In exemplary embodiments, the location information database can include a nested data structure (e.g. a location information record corresponding to a single IP address may contain several location information records). For example, a business may have leased a single access point such as a router or gateway from a telecommunications provider and have an extensive internal network that spans various physical locations. Accordingly, the business can employ an internal location information database that contains the physical location information corresponding to the internal IP addresses. In exemplary embodiments, the internal location information database can be accessed by the location information database upon receiving a request for the location information record that corresponds to an IP address that corresponds to the business. Alternatively, the internal location information database can be uploaded to the location information server by the business. The internal location information database can contain address information specified by the business including, but not limited to, room number, cubicle number, hallway, suite, floor, and the like.

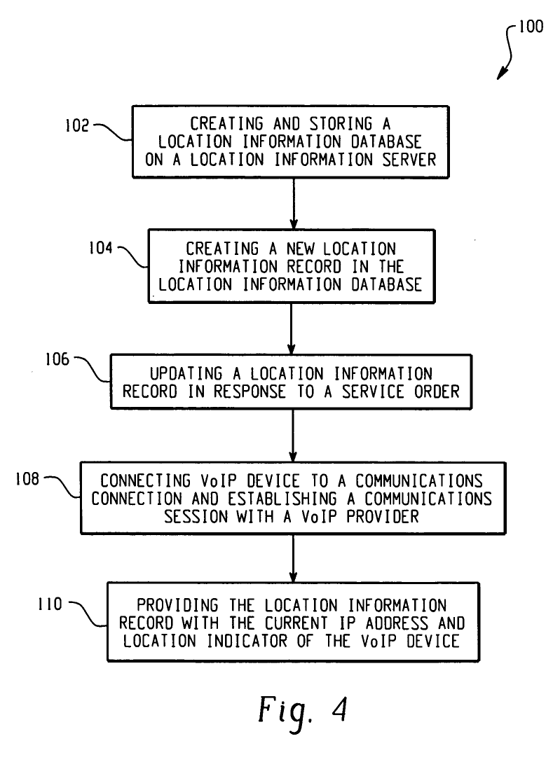

Referring now to FIG. 4, a flow chart of a method for maintaining a location information database is depicted generally as 100. As shown at process block 102 the location information database is created and stored on a location information server. The location information server is in operable communication with a loop facility assignment control system. Each time a new service order is created in the loop facility assignment control system that establishes a new communications connection to a physical location, a new location information record is created that corresponds to the new physical location, as shown at process block 104. Additionally, each time a service order is created in the loop facility assignment control system that affects the data stored in the location information record, the location information record is automatically updated, as shown at process block 106.

Continuing with reference to FIG. 4, once a VoIP device is connected to a communications connection at a physical location the VoIP device receives an IP address and establishes a communications session with a VoIP provider, as shown at process block 108. The VoIP provider receives one or more location identifiers during the communications session with the VoIP device, the location identifiers may include, but are not limited to, a network address port ID, a circuit ID, one or more tunnel identifiers, or the like. The VoIP provider communicates with the location information server to update the location information record with the location indicator corresponding to the VoIP address and with the current IP address of the VoIP device, as shown at process block 110. In alternative exemplary embodiments, the VoIP device may communicate one or more location identifiers to the location information server to update the location information record corresponding to the VoIP device.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing location information for VoIP emergency calling comprising:
providing a location information database in operable communication with a location information server;
maintaining a location information record corresponding to a physical location;
associating a VoIP device with a location information record;
receiving a request for the physical location of the VoIP device; and
providing the physical location of the VoIP device.

2. The method of claim 1, further comprising updating the location information record to reflect a change in the physical location of the VoIP device.

3. The method of claim 1, further comprising disassociating a VoIP device with an location information record when the VoIP device is disconnected from the physical location.

4. The method of claim 1, wherein the location information record comprises at least one of the following:
an Internet Protocol address field;
a network interface field;
a facility identification field;
a cable or wire identification field;
a living unit identification field; and
a living unit address field.

5. The method of claim 1, wherein the request for the physical location of the VoIP device includes an Internet Protocol address of the VoIP device.

6. The method of claim 1, further comprising adding a new location information record to the location information database corresponding to a new physical location.

7. The method of claim 1, wherein the location information database comprises a nested data structure.

8. A computer program product for providing location information for VoIP emergency calling, the computer program product comprising:
a storage medium readable by a processing circuit and storing instructions for execution by the processing circuit for facilitating a method comprising:
providing a location information database in operable communication a with a location information server;
maintaining a location information record corresponding to a physical location;
associating a VoIP device with a location information record;
receiving a request for the physical location of the VoIP device; and
providing the physical location of the VoIP device.

9. The computer program product of claim 8, further comprising updating the location information record to reflect a change in the physical location.

10. The computer program product of claim 8, further comprising disassociating a VoIP device with an location information record when the VoIP device is disconnected from the physical location.

11. The computer program product of claim 8, wherein the location information record comprises at least one of the following:
an Internet Protocol address field;
a network interface field;
a facility identification field;
a cable or wire identification field;
a living unit identification field; and
a living unit address field.

12. The computer program product of claim 8, wherein the request for the physical location of the VoIP device includes an Internet Protocol address of the VoIP device.

13. The computer program product of claim 8, further comprising adding a new location information record to the location information database corresponding to a new physical location.

14. A system for providing location information for VoIP emergency calling comprising:
means for operating a location information database;
means for maintaining a location information record corresponding to a physical location;
means for associating a VoIP device with a location information record;
means for receiving a request for the physical location of the VoIP device; and
means for providing the physical location of the VoIP device.

15. The system of claim 14, further comprising means for updating the location information record to reflect a change in the physical location of the VoIP device.

16. The system of claim 14, further comprising means for disassociating a VoIP device with an location information record when the VoIP device is disconnected from the physical location.

17. The system of claim 14, wherein the location information record comprises at least one of the following:
an Internet Protocol address field;
a network interface field;
a facility identification field;
a cable or wire identification field;
a living unit identification field; and
a living unit address field.

18. The system of claim 14, wherein the request for the physical location of the VoIP device includes an Internet Protocol address of the VoIP device.

19. The system of claim 15, further comprising adding a new location information record to the location information database corresponding to a new physical location.
